(19) United States
(12) Patent Application Publication
(10) Pub. No.: US 2025/0347848 A1
(43) Pub. Date: Nov. 13, 2025

(54) OPTICAL DEVICE, OPTICAL RECEIVER, AND OPTICAL TRANSMITTER

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 19/045,105

(22) Filed: Feb. 4, 2025

(30) Foreign Application Priority Data
May 13, 2024 (JP) 2024-078211

(51) Int. Cl. G02B 6/122; G02B 6/12; H04B 10/40; H04B 10/516

(52) U.S. Cl. CPC G02B 6/1228; H04B 10/516; G02B 2006/12061; G02B 2006/12097; H04B 10/40

(57) ABSTRACT

An optical device includes a channel waveguide that has a waveguide width that increases in a tapered manner, and a rib waveguide that is connected to a side at which the waveguide width of the channel waveguide is increased and that includes a rib portion and slab portions. The rib waveguide includes a tapered waveguide in which a rib width of the rib portion increases in a tapered manner with distance from a part at a side at which the channel waveguide is connected.

### CROSS-REFERENCE TO RELATED APPLICATION

This application is based upon and claims the benefit of priority of the prior Japanese Patent Application No. 2024-078211, filed on May 13, 2024, the entire contents of which are incorporated herein by reference.

### FIELD

The embodiments discussed herein are related to an optical device, an optical receiver, and an optical transmitter.

### BACKGROUND

FIG. 12 is a schematic plan view illustrating an example of a conventional Edge Coupler (EC) 200. The EC 200 illustrated in FIG. 12 is a substrate-type optical waveguide element that is arranged in the vicinity of a chip end face D1 and that is optically coupled with a core C of an optical fiber F. Further, the EC 200 is a spot-size converter that brings a spot size of signal light or local oscillation light closer to a mode field diameter of the optical fiber F, for example.

The EC 200 includes a clad 222 that is made of, for example, SiO₂ or the like, and an optical waveguide 210 that is covered by the clad 222 and that is made of, for example, Si or the like. The optical waveguide 210 is, for example, an optical waveguide that has a channel structure. The optical waveguide 210 includes a tapered waveguide 211 and a linear waveguide 212 that is connected to the tapered waveguide 211. The tapered waveguide 211 has a structure in which a waveguide width gradually increases with distance from a start point of the tapered waveguide 211. The linear waveguide 212 is a waveguide that is connected to a side at which the waveguide width of the tapered waveguide 211 is increased. Meanwhile, the linear waveguide 212 and the tapered waveguide 211 have same waveguide thicknesses.

FIG. 13 is a schematic cross-sectional view illustrating an example of a schematic cross-sectional portion taken along a line A-A in the EC 200 illustrated in FIG. 12. The EC 200 illustrated in FIG. 13 includes a Si substrate 221, the clad 222, and an assembly layer 223 that is arranged on the Si substrate 221. A schematic cross-sectional portion taken along the line A-A as illustrated in FIG. 13 is a cross-sectional part of the EC 200 in which the linear waveguide 212 is arranged. The linear waveguide 212 and the tapered waveguide 211 of the optical waveguide 210 are arranged in the assembly layer 223.
Patent Literature 1: Japanese National Publication of PCT International Application No. 2017-534926
Patent Literature 2: Japanese Laid-open Patent Publication No. 2009-251218
Patent Literature 3: U.S. Patent Application Publication No. 2019/0170941
Patent Literature 4: U.S. Pat. No. 10,162,133

However, the conventional EC 200 includes the optical waveguide 210 that has the channel structure; therefore, side wall roughening occurs due to etching at the time of formation of the optical waveguide 210 and an optical loss or optical reflection increases due to light scattering that is caused by the side wall roughening. In addition, in a portion in which the waveguide in the optical waveguide 210 is thickened, an influence of the side wall roughening is notable.

### SUMMARY

According to an aspect of an embodiment, an optical device includes a channel waveguide that has a waveguide width that increases in a tapered manner, and a rib waveguide that is connected at a side at which the waveguide width of the channel waveguide is increased and that includes a rib portion and slab portions. The rib waveguide includes a tapered waveguide in which a rib width of the rib portion increases in a tapered manner with distance from a part at a side at which the channel waveguide is connected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic plan view illustrating an example of an EC of a first embodiment;

FIG. 2A is a schematic cross-sectional view illustrating an example of a schematic cross-sectional portion taken along a line A-A in the EC illustrated in FIG. 1;

FIG. 2B is a schematic cross-sectional view illustrating an example of a schematic cross-sectional portion taken along a line B-B in the EC illustrated in FIG. 1;

FIG. 2C is a schematic cross-sectional view illustrating an example of a schematic cross-sectional portion taken along a line C-C in the EC illustrated in FIG. 1;

FIG. 3 is a schematic plan view illustrating an example of an EC of a second embodiment;

FIG. 4A is a schematic cross-sectional view illustrating an example of a schematic cross-sectional portion taken along a line A-A in the EC illustrated in FIG. 3;

FIG. 4B is a schematic cross-sectional view illustrating an example of a schematic cross-sectional portion taken along a line B-B in the EC illustrated in FIG. 3;

FIG. 4C is a schematic cross-sectional view illustrating an example of a schematic cross-sectional portion taken along a line C-C in the EC illustrated in FIG. 3;

FIG. 4D is a schematic cross-sectional view illustrating an example of a schematic cross-sectional portion taken along a line D-D in the EC illustrated in FIG. 3;

FIG. 5 is a schematic plan view illustrating an example of an EC of a third embodiment;

FIG. 6A is a schematic cross-sectional view illustrating an example of a schematic cross-sectional portion taken along a line A-A in the EC illustrated in FIG. 5;

FIG. 6B is a schematic cross-sectional view illustrating an example of a schematic cross-sectional portion taken along a line B-B in the EC illustrated in FIG. 5;

FIG. 6C is a schematic cross-sectional view illustrating an example of a schematic cross-sectional portion taken along a line C-C in the EC illustrated in FIG. 5;

FIG. 6D is a schematic cross-sectional view illustrating an example of a schematic cross-sectional portion taken along a line D-D in the EC illustrated in FIG. 5;

FIG. 7 is a schematic plan view illustrating an example of an EC of a fourth embodiment;

FIG. 8 is a schematic cross-sectional view illustrating an example of a schematic cross-sectional portion taken along a line A-A in the EC illustrated in FIG. 7;

FIG. 9 is a diagram for explaining an example of an optical transceiver of one embodiment;

FIG. 10 is a schematic plan view illustrating an example of an EC of a comparative example;

FIG. 11 is a schematic cross-sectional view illustrating an example of a schematic cross-sectional portion taken along a line A-A in the EC illustrated in FIG. 10;

FIG. 12 is a schematic plan view illustrating an example of a conventional EC; and

FIG. 13 is a schematic cross-sectional view illustrating an example of a schematic cross-sectional portion taken along a line A-A in the EC illustrated in FIG. 12.

### DESCRIPTION OF EMBODIMENTS

In the conventional EC 200, the optical waveguide 210 has a channel structure, and therefore, optical scattering occurs due to side wall roughening. To cope with this, the applicants of the present application propose an EC 100 of a comparative example that is able to cope with the situation as described above.

### Comparative Example

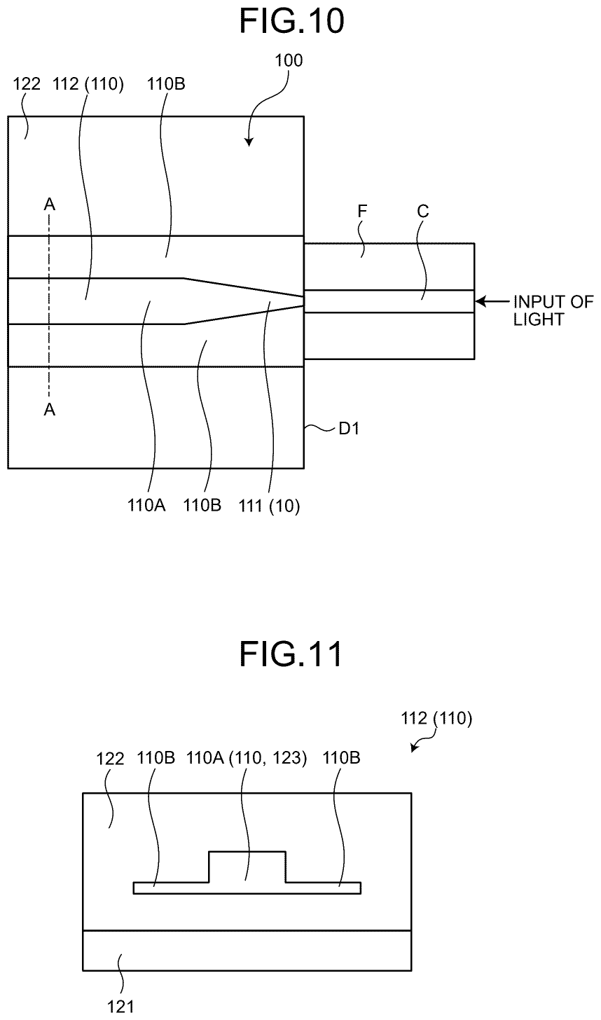

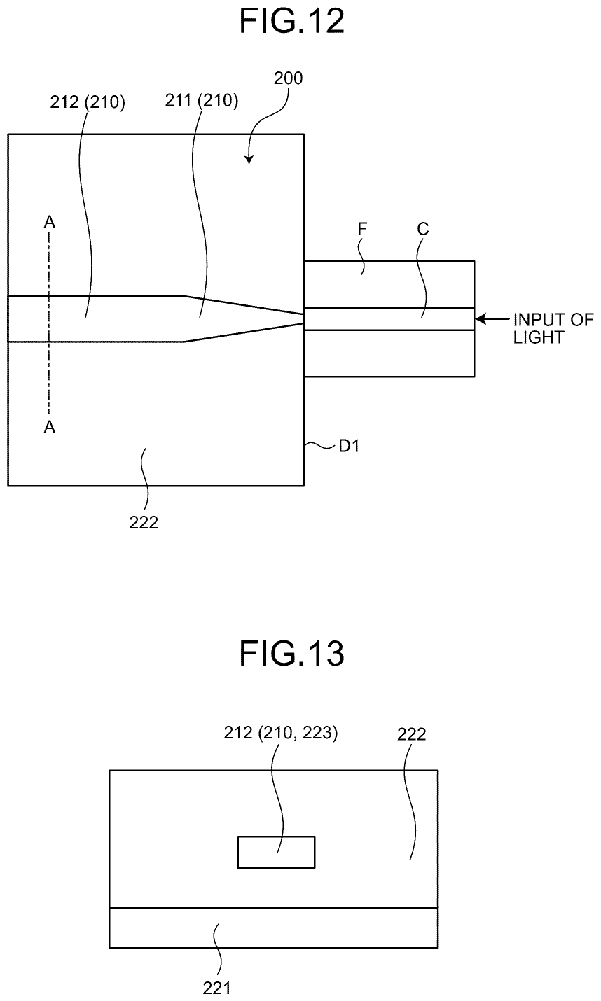

FIG. 10 is a schematic plan view illustrating an example of the EC 100 of the comparative example. The EC 100 illustrated in FIG. 10 is a part of a substrate-type optical waveguide element that is arranged in the vicinity of the chip end face D1 and that is optically coupled with the core C of the optical fiber F. Further, the EC 100 is a spot-size converter that brings a spot size of signal light or local oscillation light closer to a mode field diameter of the optical fiber F, for example.

The EC 100 includes a clad 122 that is made of, for example, SiO₂ or the like, and an optical waveguide 110 that is covered by the clad 122 and that is made of, for example, Si or the like. The optical waveguide 110 is, for example, a rib waveguide that includes a rib portion 110A and slab portions 110B that are arranged on both sides of the rib portion 110A and that have thinner thicknesses than the rib portion 110A. The optical waveguide 110 includes a tapered waveguide 111 and a linear waveguide 112 that is connected to the tapered waveguide 111. The tapered waveguide 111 has a structure in which a waveguide width gradually increases with distance from a start point of the tapered waveguide 111. The linear waveguide 112 is a waveguide that is connected to a side at which the waveguide width of the tapered waveguide 111 is increased and that has a constant waveguide width. Meanwhile, the linear waveguide 112 and the tapered waveguide 111 have same waveguide thicknesses.

FIG. 11 is a schematic cross-sectional view illustrating an example of a schematic cross-sectional portion taken along a line A-A in the EC 100 illustrated in FIG. 10. The EC 100 illustrated in FIG. 11 includes a Si substrate 121, the clad 122, and an assembly layer 123 that is arranged on the Si substrate 121. A schematic cross-sectional portion taken along the line A-A as illustrated in FIG. 11 is a cross-sectional part of the EC 100 in which the linear waveguide 112 is arranged. The linear waveguide 112 of the optical waveguide 110 is arranged in the assembly layer 123. Further, the tapered waveguide 111 of the optical waveguide 110 is arranged in the assembly layer 123.

In the EC 100 of the comparative example, the optical waveguide 110 has the rib structure; therefore, side wall roughening does not occur and it is possible to prevent an optical coupling loss and optical reflection due to optical scattering that is caused by the side wall roughening.

However, in the EC 100 of the comparative example, because the optical waveguide 110 has the rib structure, optical confinement of the tapered waveguide 111 of the optical waveguide 110 is strong and it is difficult to increase a mode field.

Preferred embodiments of the present invention will be explained with reference to accompanying drawings. Meanwhile, the present invention is not limited by the embodiments below. In addition, the embodiments described below may be combined appropriately as long as no contradiction is derived.

### (a) First Embodiment

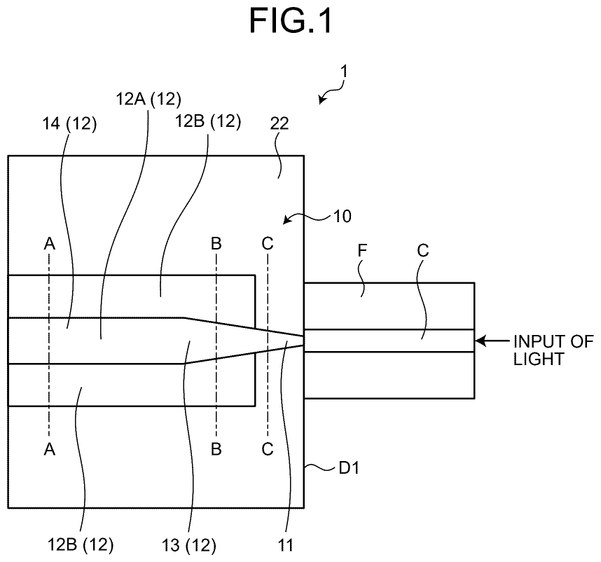

FIG. 1 is a schematic plan view illustrating an example of an EC 1 of a first embodiment. The EC 1 illustrated in FIG. 1 is a part of a substrate-type optical waveguide element that is arranged in the vicinity of the chip end face D1 and that is optically coupled with the core C of the optical fiber F. Further, the EC 1 is a spot-size converter that brings a spot size of signal light or local oscillation light closer to a mode field diameter of the optical fiber F, for example.

The EC 1 includes a clad 22 that is made of, for example, SiO₂ or the like, and an optical waveguide 10 that is covered by the clad 22 and that is made of, for example, Si or the like. The optical waveguide 10 includes a channel waveguide 11 in which a waveguide width increases in a tapered manner from the vicinity of the chip end face D1, and a rib waveguide 12 that is connected at a side at which the width of the channel waveguide 11 is increased and that includes a rib portion 12A and slab portions 12B. The channel waveguide 11 is configured with a tapered waveguide in which a waveguide width gradually increases with distance from the vicinity of the chip end face D1.

The rib waveguide 12 includes the rib portion 12A and the slab portions 12B that are formed on both sides of the rib portion 12A and that have thinner thicknesses than the rib portion 12A. The rib waveguide 12 includes a tapered waveguide 13 and a linear waveguide 14 that is connected to the tapered waveguide 13. The tapered waveguide 13 is connected at a side at which the waveguide width of the channel waveguide 11 is increased and has a structure in which a waveguide width gradually increases with distance from a start point of the tapered waveguide 13. The linear waveguide 14 is a linear waveguide that is connected at a side at which the waveguide width of the tapered waveguide 13 is increased and that has a constant waveguide width. Meanwhile, the linear waveguide 14 and the tapered waveguide 13 have same waveguide thicknesses. In other words, a rib width of the rib portion 12A of the rib waveguide 12 increases in a tapered manner with distance from a part that is connected to the channel waveguide 11.

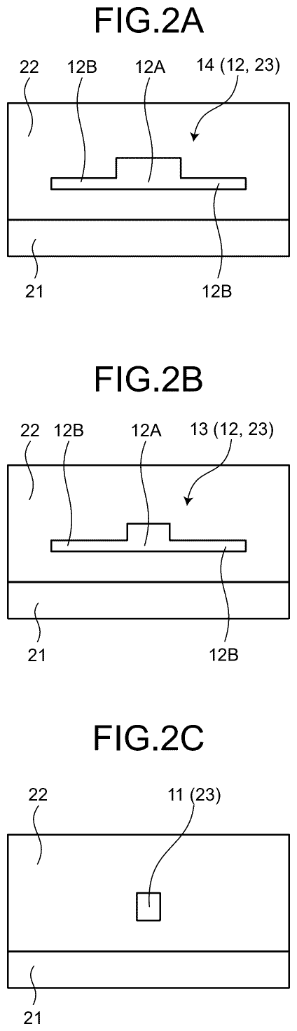

FIG. 2A is a schematic cross-sectional view illustrating an example of a schematic cross-sectional portion taken along a line A-A in the EC 1 illustrated in FIG. 1. The EC 1 illustrated in FIG. 2A includes a Si substrate 21, the clad 22, and a first assembly layer 23 that is arranged on the Si substrate 21. A schematic cross-sectional portion taken along the line A-A as illustrated in FIG. 2A is a cross-sectional part of the EC 1 in which the linear waveguide 14 in the rib waveguide 12 is arranged. The linear waveguide 14 of the rib waveguide 12 is arranged in the first assembly layer 23.

FIG. 2B is a schematic cross-sectional view illustrating an example of a schematic cross-sectional portion taken along a line B-B in the EC 1 illustrated in FIG. 1. The EC 1 illustrated in FIG. 2B includes the Si substrate 21, the clad 22, and the first assembly layer 23. A schematic cross-sectional portion taken along the line B-B as illustrated in FIG. 2B is a cross-sectional part of the EC 1 in which the tapered waveguide 13 in the rib waveguide 12 is arranged. The tapered waveguide 13 in the rib waveguide 12 is arranged in the first assembly layer 23.

FIG. 2C is a schematic cross-sectional view illustrating an example of a schematic cross-sectional portion taken along a line C-C in the EC 1 illustrated in FIG. 1. The EC 1 illustrated in FIG. 2C includes the Si substrate 21, the clad 22, and the first assembly layer 23. A schematic cross-sectional portion taken along the line C-C as illustrated in FIG. 2C is a cross-sectional part of the EC 1 in which the channel waveguide 11 is arranged. The channel waveguide 11 is arranged in the first assembly layer 23.

In the EC 1 of the first embodiment, the rib waveguide 12 is adopted in a part of the optical waveguide; therefore, side wall roughening does not occur and it is possible to prevent an optical coupling loss and optical reflection due to optical scattering that is caused by the side wall roughening. Further, the EC 1 adopts the channel waveguide 11 in a portion in the optical waveguide 10 that is optically coupled with the optical fiber F, so that optical confinement is weak and it is possible to increase a mode field. Furthermore, the EC 1 enables spot size conversion with low loss. Moreover, in the EC 1, the core width is reduced even when the channel waveguide 11 is adopted in the portion that is optically coupled with the optical fiber F, so that it is possible to reduce an influence caused by side wall roughening.

The example has been described in which slab width of each of the slab portions 12B of the tapered waveguide 13 of the rib waveguide 12 of the first embodiment is constant. However, embodiments are not limited to this example; for example, slab widths of the tapered waveguide 13 of the rib waveguide 12 may be gradually decreased from parts that are connected to the slab portions 12B of the linear waveguide 14 toward the channel waveguide 11, and an appropriate modification may be made. In this case, the slab widths of the tapered waveguide 13 gradually approach the channel waveguide 11, so that a change of the mode field can be made moderate.

Furthermore, in the EC 1 of the first embodiment, the spot-size converter including the optical waveguide 10 that includes the channel waveguide 11 and the rib waveguide 12 and that is made of Si is described by way of example, but in some cases, it may be difficult to fully increase the mode field by only the optical waveguide 10 that is made of Si. Therefore, an embodiment that copes with the situation as described above will be described below as a second embodiment.

### (b) Second Embodiment

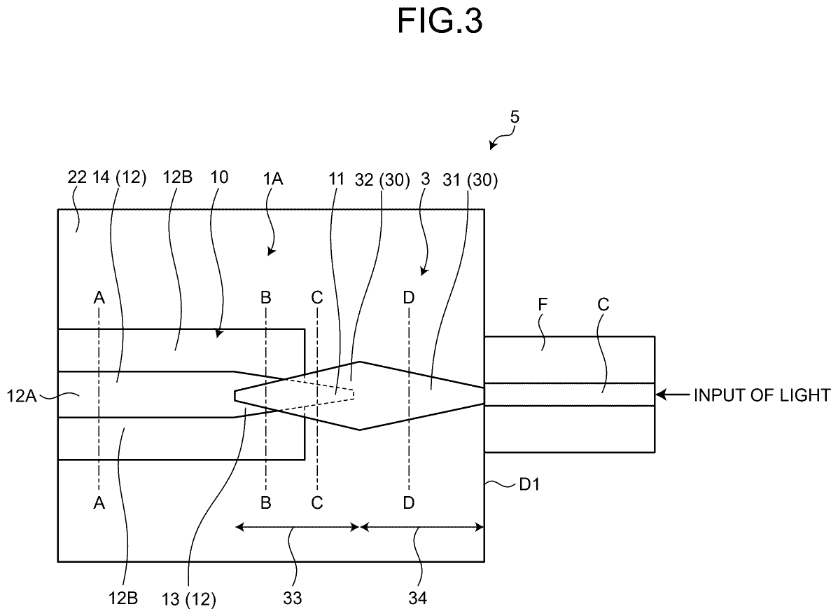

FIG. 3 is a schematic plan view illustrating an example of an EC 5 of the second embodiment. Meanwhile, the same components as those of the EC 1 of the first embodiment are denoted by the same reference symbols, and explanation of the same components and the same operation will be omitted. The EC 5 illustrated in FIG. 3 includes a first EC 1A and a second EC 3. Meanwhile, the first EC 1A is the EC 1 of the first embodiment that includes the channel waveguide 11 and the rib waveguide 12 that is connected to the channel waveguide 11.

The second EC 3 includes the clad 22 that is made of SiO₂ or the like and a SiN waveguide 30 that is covered by the clad 22 and that is made of, for example, Si₃N₄ (hereinafter, simply referred to as Silicon Nitride (SiN)) or the like. The SiN waveguide 30 includes a first tapered waveguide 31 and a second tapered waveguide 32 that is connected to the first tapered waveguide 31. The first tapered waveguide 31 has a structure in which a waveguide width gradually increases from an optical input-output unit in the vicinity of the chip end face D1 toward the second tapered waveguide 32. The second tapered waveguide 32 has a structure in which a waveguide width gradually decreases from, as a start point, a portion that is connected to the first tapered waveguide 31, with distance from the first tapered waveguide 31. The second tapered waveguide 32 is referred to as a different tapered waveguide.

The EC 5 includes a transition unit 33 that enables adiabatic transition of light between the channel waveguide 11 in the first EC 1A and the second tapered waveguide 32 in the SiN waveguide 30 in the second EC 3, and an inverse tapered portion 34 that has a structure in which a waveguide width gradually decreases toward the chip end face D1. The inverse tapered portion 34 is the first tapered waveguide 31 of the SiN waveguide 30 that is arranged in the vicinity of the chip end face D1 and that guides signal light coming from the optical fiber F1.

The transition unit 33 includes a part of the tapered waveguide 13, the channel waveguide 11, and the second tapered waveguide 32, and enables transition of light between a set of the part of the tapered waveguide 13 and the channel waveguide 11 and the second tapered waveguide 32. In other words, in the transition unit 33, signal light coming from the second tapered waveguide 32 transitions to the linear waveguide 14 via the channel waveguide 11 and the tapered waveguide 13 that has the rib structure.

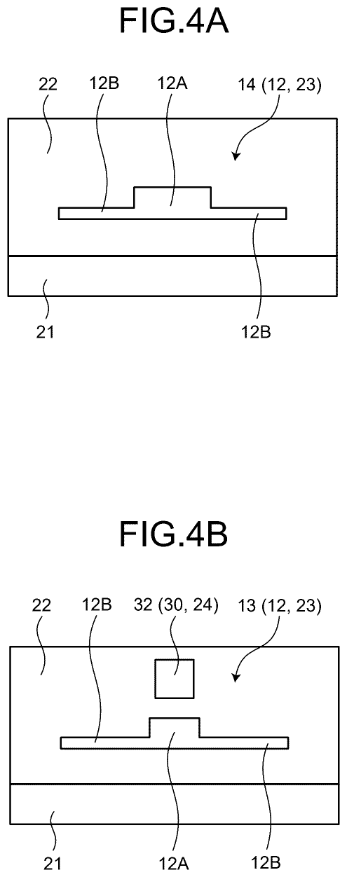

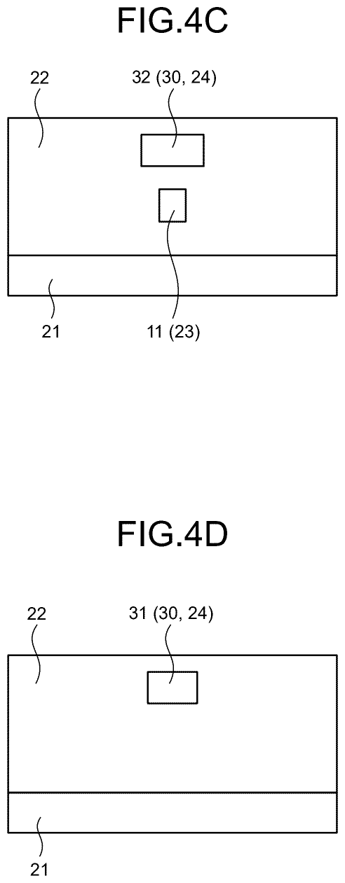

FIG. 4A is a schematic cross-sectional view illustrating an example of a schematic cross-sectional portion taken along a line A-A in the EC 5 illustrated in FIG. 3. The EC 5 illustrated in FIG. 4A includes the Si substrate 21, the clad 22, the first assembly layer 23 that is arranged at a side close to the Si substrate 21, and a second assembly layer 24 that is arranged at a side distant from the Si substrate 21. A schematic cross-sectional portion taken along the line A-A as illustrated in FIG. 4A is a cross-sectional part of the first EC 1A in which the linear waveguide 14 in the rib waveguide 12 is arranged. In the first assembly layer 23, the linear waveguide 14 of the rib waveguide 12 is arranged.

FIG. 4B is a schematic cross-sectional view illustrating an example of a schematic cross-sectional portion taken along a line B-B in the EC 5 illustrated in FIG. 3. The EC 5 illustrated in FIG. 4B includes the Si substrate 21, the clad 22, the first assembly layer 23, and the second assembly layer 24. A schematic cross-sectional portion taken along the line B-B as illustrated in FIG. 4B is a cross-sectional part of the transition unit 33 in which the tapered waveguide 13 in the rib waveguide 12 is arranged. In the first assembly layer 23, the tapered waveguide 13 in the rib waveguide 12 is arranged. In the second assembly layer 24, the second tapered waveguide 32 of the SiN waveguide 30 is arranged. In other words, the second tapered waveguide 32 of the SiN waveguide 30 is arranged in a different layer from the rib waveguide 12 in a location that overlaps with the tapered waveguide 13 of the rib waveguide 12 in a plane direction.

FIG. 4C is a schematic cross-sectional view illustrating an example of a schematic cross-sectional portion taken along a line C-C in the EC 5 illustrated in FIG. 3. The EC 5 illustrated in FIG. 4C includes the Si substrate 21, the clad 22, the first assembly layer 23, and the second assembly layer 24. A schematic cross-sectional portion taken along the line C-C as illustrated in FIG. 4C is a cross-sectional part of the transition unit 33 in which the channel waveguide 11 is arranged. In the first assembly layer 23, the channel waveguide 11 is arranged. In the second assembly layer 24, the second tapered waveguide 32 in the second EC 3 is arranged. In other words, the second tapered waveguide 32 of the SiN waveguide 30 is arranged in a different layer from the channel waveguide 11 in a location that overlaps with the channel waveguide 11 in a plane direction.

FIG. 4D is a schematic cross-sectional view illustrating an example of a schematic cross-sectional portion taken along a line D-D in the EC 5 illustrated in FIG. 3. The EC 5 illustrated in FIG. 4D includes the Si substrate 21, the clad 22, the first assembly layer 23, and the second assembly layer 24. A schematic cross-sectional portion taken along the line D-D illustrated in FIG. 4D is a cross-sectional part of the inverse tapered portion 34 in which the first tapered waveguide 31 is arranged. In the second assembly layer 24, the first tapered waveguide 31 is arranged.

The transition unit 33 includes the channel waveguide 11 that is made of Si, and therefore, has an effect to weaken optical confinement as compared to a case in which only a rib waveguide that is made of Si is included. This effect is notable especially when light to be guided is TE light. Therefore, in the transition unit 33, a mode field of TE light that transitions from the channel waveguide 11 to the second tapered waveguide 32 of the SiN waveguide 30 increases, and efficiency of transition of the TE light from the channel waveguide 11 to the SiN waveguide 30 increases. As a result, it is possible to improve efficiency of adiabatic conversion of TE light in the transition unit 33.

In the EC 5 of the second embodiment, the rib waveguide 12 is adopted as a part of the optical waveguide 10 of the first EC 1A; therefore side wall roughening does not occur and it is possible to prevent an optical coupling loss and optical reflection due to optical scattering that is caused by the side wall roughening. In the first EC 1A, the channel waveguide 11 is adopted as a transition portion with respect to the second tapered waveguide 32 of the SiN waveguide 30, so that optical confinement is weak and it is possible to increase a mode field. In addition, in the first EC 1A, even when the channel waveguide 11 is adopted as the transition portion with respect to the second tapered waveguide 32, the core width is reduced, so that it is possible to prevent an influence that is caused by the side wall roughening.

For example, when the transition unit uses a rib waveguide instead of the channel waveguide 11 and TE light transitions from the rib waveguide to the second tapered waveguide 32, optical confinement is strengthened in the rib waveguide, transition efficiency of the TE light is degraded, and a loss of the TE light increases. In contrast, the transition unit 33 according to the present embodiment increases a mode field of TE light that transitions from the channel waveguide 11 to the second tapered waveguide 32 of the SiN waveguide 30. In addition, optical confinement in the channel waveguide 11 is weak, so that it is possible to largely improve the transition efficiency of the TE light from the channel waveguide 11 to the SiN waveguide 30. As a result, it is possible to improve efficiency of adiabatic conversion of the TE light in the transition unit 33 and improve a loss of the TE light.

The EC 5 allows signal light coming from the optical fiber F to propagate through the transition unit 33 by using the inverse tapered portion 34. In the transition unit 33, waveguide widths of the channel waveguide 11 that is made of Si and the second tapered waveguide 32 that is made of SiN are changed in a tapered manner. The second tapered waveguide 32 that is made of SiN has a lower refractive index than the channel waveguide 11 that is made of Si, so that it is possible to fully increase a mode field of signal light, and it is further possible to reduce a coupling loss of TE light and TM light with respect to the optical fiber F and improve coupling efficiency because of small polarization dependence.

Meanwhile, in the rib waveguide 12 of the first EC 1A of the second embodiment, the slab portions 12B have constant widths. Therefore, in the transition unit 33 that includes the tapered waveguide 13 and the channel waveguide 11, a slab width largely changes between the tapered waveguide 13 and the channel waveguide 11, so that a mode field may largely change and a radiation loss may occur. Therefore, an embodiment that copes with the situation as described above will be described below as a third embodiment.

### (c) Third Embodiment

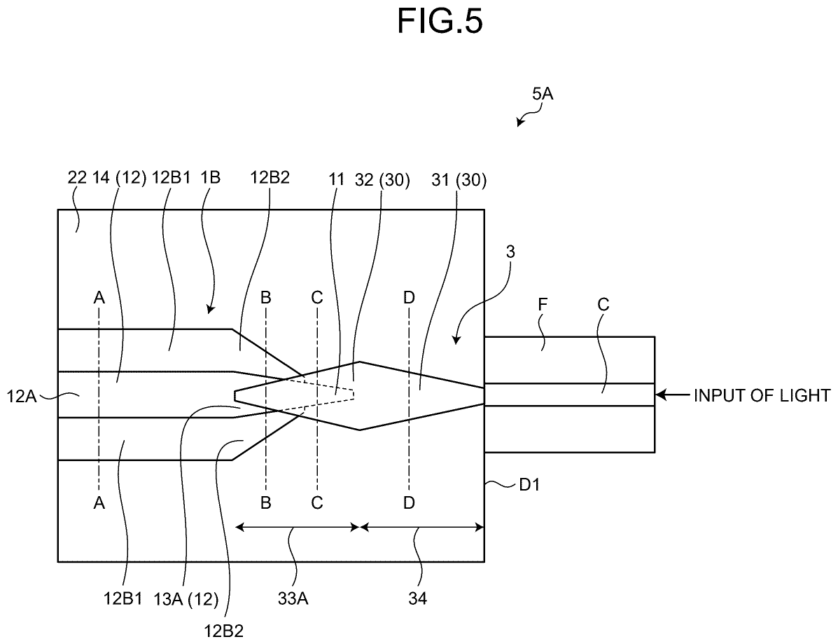

FIG. 5 is a schematic plan view illustrating an example of an EC 5A of the third embodiment. Meanwhile, the same components as those of the EC 5 of the second embodiment are denoted by the same reference symbols, and explanation of the same components and the same operation will be omitted. The EC 5 of the second embodiment and the EC 5A of the third embodiment are different in that, although slab widths of slab portions 12B1 of the linear waveguide 14 of the rib waveguide 12 are constant, slab widths of slab portions 12B2 of a tapered waveguide 13A of the rib waveguide 12 are continuously changed.

A slab width of each of the slab portions 12B2 of the tapered waveguide 13A of the rib waveguide 12 is continuously changed so as to gradually decrease from a part that is connected to each of the slab portions 12B1 of the linear waveguide 14 toward the channel waveguide 11. A transition unit 33A enables adiabatic transition of light between the tapered waveguide 13A that is made of Si and the channel waveguide 11 and the second tapered waveguide 32 that is made of SiN. As a result, the slab widths of the slab portions 12B2 of the tapered waveguide 13A gradually approach the channel waveguide 11, so that it is possible to prevent a situation in which a mode field rapidly changes.

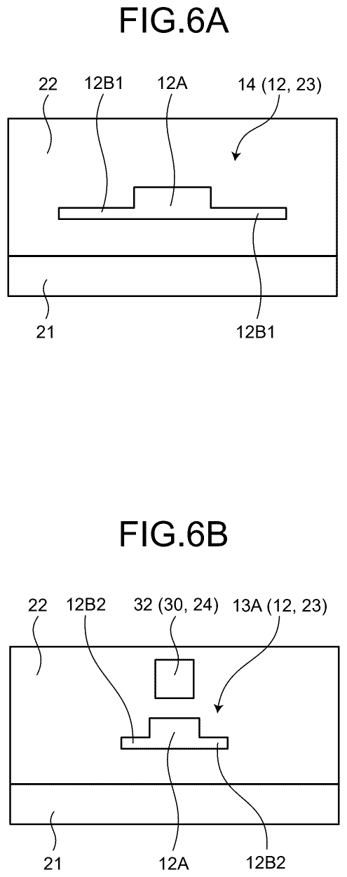

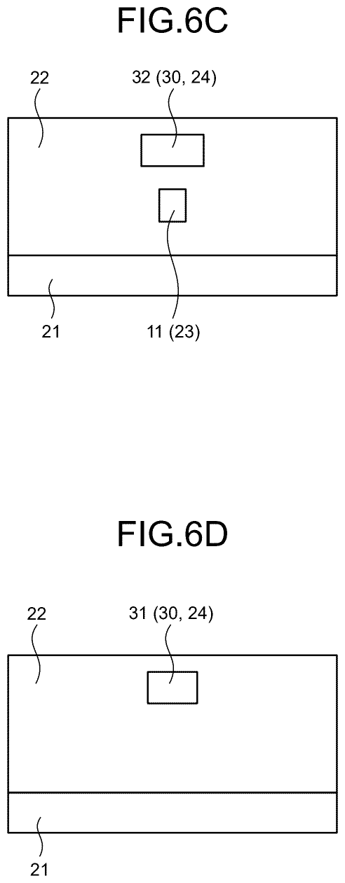

FIG. 6A is a schematic cross-sectional view illustrating an example of a schematic cross-sectional portion taken along a line A-A in the EC 5A illustrated in FIG. 5. The EC 5A illustrated in FIG. 6A includes the Si substrate 21, the clad 22, the first assembly layer 23, and the second assembly layer 24. A schematic cross-sectional portion taken along the line A-A as illustrated in FIG. 6A is a cross-sectional part of a first EC 1B in which the linear waveguide 14 in the rib waveguide 12 is arranged. In the first assembly layer 23, the linear waveguide 14 of the rib waveguide 12 is arranged.

FIG. 6B is a schematic cross-sectional view illustrating an example of a schematic cross-sectional portion taken along a line B-B in the EC 5A illustrated in FIG. 5. The EC 5A illustrated in FIG. 6B includes the Si substrate 21, the clad 22, the first assembly layer 23, and the second assembly layer 24. A schematic cross-sectional portion taken along the line B-B as illustrated in FIG. 6B is a cross-sectional part of the transition unit 33A in which the tapered waveguide 13A in the rib waveguide 12 is arranged. In the first assembly layer 23, the tapered waveguide 13A in the rib waveguide 12 is arranged. In the second assembly layer 24, the second tapered waveguide 32 in the SiN waveguide 30 is arranged. In other words, the second tapered waveguide 32 of the SiN waveguide 30 is arranged in a different layer from the rib waveguide 12 in a location that overlaps with the tapered waveguide 13A of the rib waveguide 12 in a plane direction.

FIG. 6C is a schematic cross-sectional view illustrating an example of a schematic cross-sectional portion taken along a line C-C in the EC 5A illustrated in FIG. 5. The EC 5A illustrated in FIG. 6C includes the Si substrate 21, the clad 22, the first assembly layer 23, and the second assembly layer 24. A schematic cross-sectional portion taken along the line C-C as illustrated in FIG. 6C is a cross-sectional part of the transition unit 33A in which the channel waveguide 11 is arranged. In the first assembly layer 23, the channel waveguide 11 is arranged. In the second assembly layer 24, the second tapered waveguide 32 in the SiN waveguide 30 is arranged. In other words, the second tapered waveguide 32 of the SiN waveguide 30 is arranged in a different layer from the rib waveguide 12 in a location that overlaps with the channel waveguide 11 in a plane direction.

FIG. 6D is a schematic cross-sectional view illustrating an example of a schematic cross-sectional portion taken along a line D-D in the EC 5A illustrated in FIG. 5. The EC 5A illustrated in FIG. 6D includes the Si substrate 21, the clad 22, the first assembly layer 23, and the second assembly layer 24. A schematic cross-sectional portion taken along the line D-D as illustrated in FIG. 6D is a cross-sectional part of the inverse tapered portion 34 in which the first tapered waveguide 31 is arranged. In the second assembly layer 24, the first tapered waveguide 31 is arranged.

A slab width of each of the slab portions 12B2 of the tapered waveguide 13A of the rib waveguide 12 in the EC 5A of the third embodiment gradually decreases from a part that is connected to each of the slab portions 12B1 of the linear waveguide 14 toward the channel waveguide 11. In other words, the slab widths of the slab portions 12B2 of the tapered waveguide 13A gradually approach the channel waveguide 11, so that a change of the slab widths can be made moderate. As a result, a change of a mode field between the tapered waveguide 13A and the channel waveguide 11 is made moderate, so that it is possible to prevent occurrence of a radiation loss.

In addition, in the EC 5A, the rib waveguide 12 is adopted as a part of the optical waveguide 10; therefore, side wall roughening does not occur and it is possible to prevent an optical coupling loss and optical reflection due to optical scattering that is caused by the side wall roughening. In the first EC 1B, the channel waveguide 11 is adopted as a transition portion with respect to the second tapered waveguide 32 of the SiN waveguide 30, so that optical confinement is weak and it is possible to increase a mode field.

The EC 5A allows signal light coming from the optical fiber F to propagate through the transition unit 33A by using the inverse tapered portion 34. In the transition unit 33A, the waveguide widths of the channel waveguide 11 that is made of Si and the second tapered waveguide 32 that is made of SiN are changed in a tapered manner. The second tapered waveguide 32 that is made of SiN has a lower refractive index than the channel waveguide 11 that is made of Si, so that it is possible to fully increase a mode field of signal light, and it is further possible to reduce a coupling loss of TE light and TM light with respect to the optical fiber F and improve coupling efficiency because of small polarization dependence.

Meanwhile, in the EC 5A of the third embodiment, the tapered channel waveguide 11 is illustrated by way of example, but if the waveguide width of the channel waveguide 11 is too large, a coupling loss and optical reflection may increase. Therefore, an embodiment that copes with the situation as described above will be described below as a fourth embodiment.

### (d) Fourth Embodiment

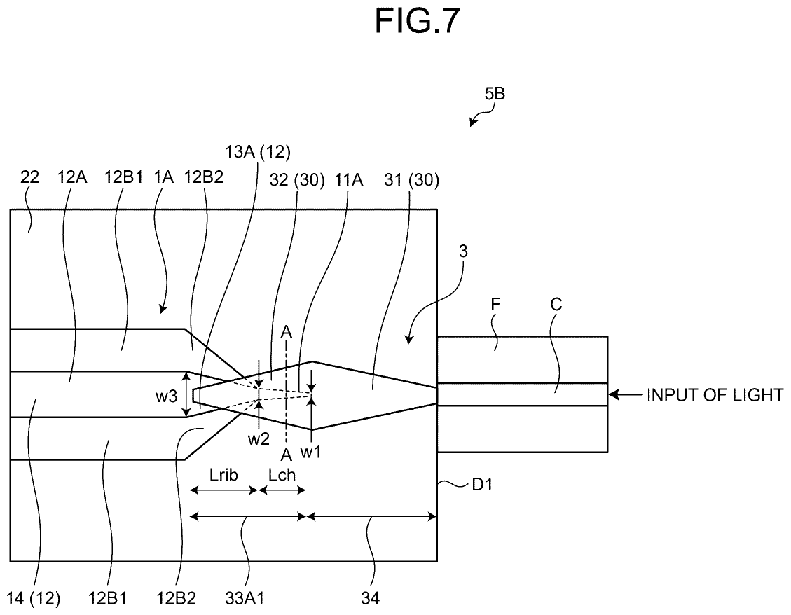

FIG. 7 is a schematic plan view illustrating an example of an EC 5B of the fourth embodiment. Meanwhile, the same components as those of the EC 5A of the third embodiment are denoted by the same reference symbols, and explanation of the same components and the same operation will be omitted. The EC 5A of the third embodiment and the EC 5B of the fourth embodiment are different in that a tapered channel waveguide 11A that has a smaller waveguide width than the tapered channel waveguide 11 is provided.

In FIG. 7, a waveguide length of the channel waveguide 11A of a transition unit 33A1 is denoted by Lch, and a waveguide length of the tapered waveguide 13A of the transition unit 33A1 is denoted by Lrib. Further, a waveguide width of the channel waveguide 11A located at a start point of the transition unit 33A1 is denoted by w1, and a waveguide width of the channel waveguide 11A located in a part that is connected to the tapered waveguide 13A of the transition unit 33A1 is denoted by w2. Furthermore, a waveguide width of the tapered waveguide 13A in a part that is connected to the linear waveguide 14 at an end point of the transition unit 33A1 is denoted by w3.

The waveguide length Lch of the channel waveguide 11A is set to a certain length that enables light to completely transition between the tapered waveguide 13A and the second tapered waveguide 32 by the transition unit 33A1. Further, the waveguide width w2 of the channel waveguide 11A is set to a certain width with which a coupling loss and optical reflection can be prevented. Furthermore, the waveguide widths have a certain relationship such that w1<w2<w3. Moreover, a taper angle α1 of the channel waveguide 11A is set to ((w2−w1)/Lch). Furthermore, a taper angle α2 of the tapered waveguide 13A of the rib waveguide 12 is set to ((w3−w2)/Lrib). The taper angle α1 of the channel waveguide 11A the channel waveguide 11A is different from the taper angle α2 of the tapered waveguide 13A.

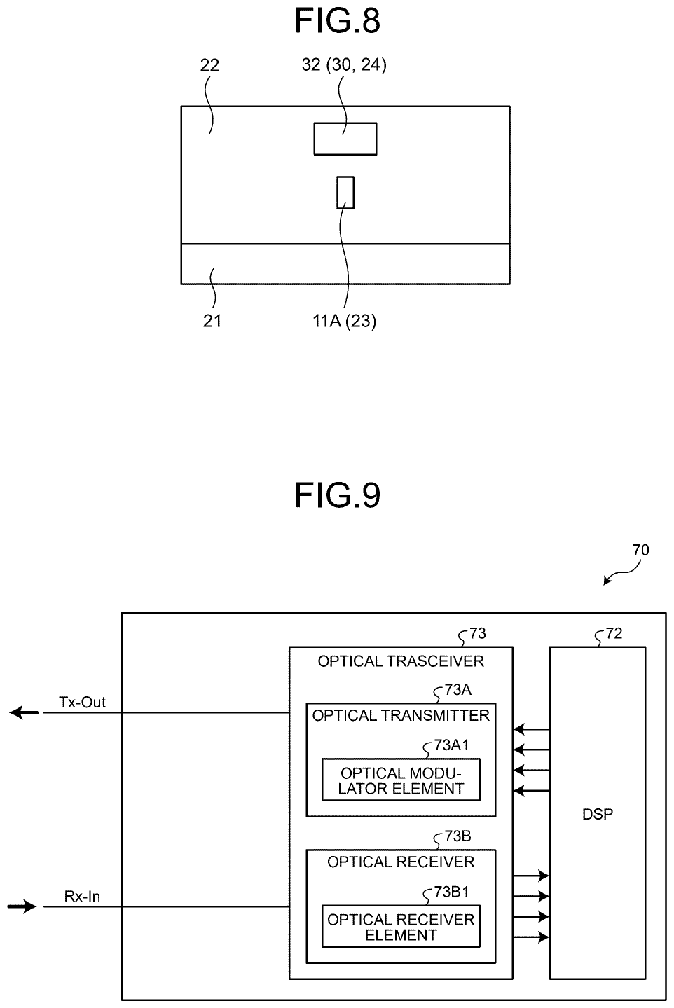

FIG. 8 is a schematic cross-sectional view illustrating an example of a schematic cross-sectional portion taken along a line A-A in the EC 5B illustrated in FIG. 7. The EC 5B illustrated in FIG. 8 includes the Si substrate 21, the clad 22, the first assembly layer 23, and the second assembly layer 24. A schematic cross-sectional portion taken along the line A-A as illustrated in FIG. 8 is a cross-sectional part of the transition unit 33A1 in which the channel waveguide 11A is arranged. In the first assembly layer 23, the channel waveguide 11A is arranged. In the second assembly layer 24, the second tapered waveguide 32 in the second EC 3 is arranged. In other words, the second tapered waveguide 32 of the SiN waveguide 30 is arranged in a different layer from the channel waveguide 11A in a location that overlaps with the channel waveguide 11A in a plane direction.

The transition unit 33A1 in the EC 5B of the fourth embodiment sets the waveguide length Lch of the channel waveguide 11A to a certain length that is needed for adiabatic conversion and sets the waveguide width w2 of the channel waveguide 11A to a certain width with which a coupling loss and optical reflection can be prevented. As a result, it is possible to prevent a coupling loss and optical reflection in the transition unit 33A1.

FIG. 9 is a diagram for explaining an example of an optical transceiver 70 according to the present embodiment. The optical transceiver 70 illustrated in FIG. 9 is connected to an optical fiber on an output side and an optical fiber on an input side. The optical transceiver 70 includes a Digital Signal Processor (DSP) 72 and an optical transceiver 73. The optical transceiver 73 includes an optical transmitter 73A and an optical receiver 73B. The DSP 72 is an electrical component that performs digital signal processing. The DSP 72 performs, for example, processing, such as encoding, on transmission data, generates an electrical signal that includes the transmission data, and outputs the generated electrical signal to the optical transmitter 73A. Further, the DSP 72 acquires an electrical signal including reception data from the optical receiver 73B, performs processing, such as decoding, on the acquired electrical signal, and obtains the reception data.

The optical transmitter 73A includes an optical modulator element 73A1 that modulates supplied light by an electrical signal that is output from the DSP 72, and outputs transmission light that is modulated by the electrical signal to the optical fiber. The optical modulator element 73A1 incorporates therein an optical device of a substrate-type optical waveguide element that guides light to be output to the optical fiber.

The optical receiver 73B includes an optical receiver element 73B1 that receives an optical signal from the optical fiber and demodulates reception light by using supplied light, converts the demodulated reception light into an electrical signal, and outputs the converted electrical signal to the DSP 72. The optical receiver element 73B1 incorporates therein an optical device of a substrate-type optical waveguide element that guides light received from the optical fiber.

The optical device in the optical transceiver 70 includes a channel waveguide in which a waveguide width increases in a tapered manner, and a rib waveguide that is connected at a side at which the width of the channel waveguide is increased and that includes a rib portion and slab portions. The rib waveguide includes a tapered waveguide in which a rib width of the rib waveguide increases in a tapered manner with distance from a part at a side at which the channel waveguide is connected. As a result, it is possible to provide an optical device or the like that is able to improve an optical coupling loss and optical reflection.

Meanwhile, for the sake of simplicity of explanation, the example has been described in which the optical transceiver 70 incorporates therein the optical transmitter 73A and the optical receiver 73B, but the optical transceiver 70 may incorporate therein any one of the optical transmitter 73A and the optical receiver 73B. For example, it may be possible to adopt an optical device to the optical transceiver 70 that incorporates therein the optical receiver 73B, and an appropriate modification may be made.

Furthermore, the components of each of the units illustrated in the drawings need not always be physically configured in the manner illustrated in the drawings. In other words, specific forms of distribution and integration of each of the units are not limited to those illustrated in the drawings, and all or part of the units may be functionally or physically distributed or integrated in arbitrary units depending on various loads or use conditions.

Moreover, all or an arbitrary part of various kinds of processing functions that are implemented by the apparatuses may be realized by a Central Processing Unit (CPU) (or a microcomputer, such as a Micro Processing Unit (MPU) or a Micro Controller Unit (MCU)). Furthermore, all or an arbitrary part of the various kinds of processing functions may be implemented by a program that is analyzed and executed by the CPU, or may be realized by hardware using wired logic.

According to one aspect, it is possible to provide an optical device or the like that is able to improve a coupling loss and optical reflection.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a channel waveguide that has a waveguide width that increases in a tapered manner; and
a rib waveguide that is connected at a side at which the waveguide width of the channel waveguide is increased and that includes a rib portion and slab portions, wherein
the rib waveguide includes a tapered waveguide in which a rib width of the rib portion increases in a tapered manner with distance from a part at a side at which the channel waveguide is connected.

2. The optical device according to claim 1, wherein slab portions of the tapered waveguide have slab widths that decrease with approach to a part at a side at which the channel waveguide is connected.

3. The optical device according to claim 1, further including a different tapered waveguide that is arranged in a different layer from the tapered waveguide and the channel waveguide in a location that overlaps with a part of the tapered waveguide and the channel waveguide in a plane direction, and that has a waveguide width that increases in a tapered manner from the tapered waveguide toward the channel waveguide.

4. The optical device according to claim 3, further including a transition portion that enables transition of light between a set of the part of the tapered waveguide and the channel waveguide and the different tapered waveguide.

5. The optical device according to claim 4, further including an inverse tapered waveguide that is connected at a side at which the waveguide width of the different tapered waveguide is increased and that has a waveguide width that decreases in a tapered manner with distance from the different tapered waveguide.

6. The optical device according to claim 5, wherein
the channel waveguide and the rib waveguide are formed of Si waveguides, and
the different tapered waveguide and the inverse tapered waveguide are formed of SiN waveguides.

7. An optical receiver comprising:
an optical receiver element that converts received signal light to an electrical signal, wherein
the optical receiver element includes
a channel waveguide that has a waveguide width that increases in a tapered manner; and
a rib waveguide that is connected at a side at which the waveguide width of the channel waveguide is increased and that has a rib portion and slab portions, and
the rib waveguide includes a tapered waveguide in which a rib width of the rib portion increases in a tapered manner with distance from a part at a side at which the channel waveguide is connected.

8. An optical transmitter comprising:
an optical modulator element that modulates guided light in accordance with an electrical signal, wherein
the optical modulator element includes
a channel waveguide that has a waveguide width that increases in a tapered manner; and
a rib waveguide that is connected at a side at which the waveguide width of the channel waveguide is increased and that has a rib portion and slab portions, and
the rib waveguide includes a tapered waveguide in which a rib width of the rib portion increases in a tapered manner with distance from a part at a side at which the channel waveguide is connected.
